(19) United States
(12) Patent Application Publication
(10) Pub. No.: US 2023/0109463 A1
(43) Pub. Date: Apr. 6, 2023

(54) PRACTICAL METHOD FOR FAST GRAPH TRAVERSAL ITERATORS ON DELTA-LOGGED GRAPHS

(71) Applicant: Oracle International Corporation, Redwood Shores, CA (US)

(72) Inventors: Damien Hilloulin, Zurich (CH); Valentin Venzin, Zurich (CH); Vasileios Trigonakis, Zurich (CH); Martin Sevenich, Palo Alto, CA (US); Alexander Weld, Mountain View, CA (US); Sungpack Hong, Palo Alto, CA (US); Hassan Chafi, San Mateo, CA (US)

(21) Appl. No.: 17/479,003

(22) Filed: Sep. 20, 2021

(51) Int. Cl. G06F 16/901; G06F 16/23; G06F 9/38

(52) U.S. Cl. CPC G06F 16/9024; G06F 9/3887; G06F 16/2358

(57) ABSTRACT

Herein is fast and memory efficient iteration of elements of a graph that has (e.g. topological) changes. In an embodiment, a computer generates an element iterator that is based on a graph that contains many elements (e.g. vertices, edges, and their properties) and a delta log that represents modification(s) of the graph. The delta log only records changes, such that only some graph elements are modified and occur in the delta log. Thus, iteration of only some graph elements may need to retrieve data from the delta log. Based on the element iterator and the delta log, a first graph element is accessed during iteration. Based on the element iterator but not the delta log, a second graph element is accessed. For example, a result may be generated that is based on the first element and the second element that were iterated based on different respective data structures.

### RELATED CASE

Incorporated in its entirety herein is related U.S. Pat. Application 17/194,165 FAST AND MEMORY EFFICIENT IN-MEMORY COLUMNAR GRAPH UPDATES WHILE PRESERVING ANALYTICAL PERFORMANCE filed on Mar. 5, 2021 by Damien Hilloulin et al.

### FIELD OF THE INVENTION

The present disclosure relates to techniques for processing logical graphs. More specifically, the disclosure relates to fast and memory efficient iteration of elements of a graph that has been (e.g. topologically) modified.

### BACKGROUND

A graph is a mathematical structure used to model relationships between entities. A graph consists of a set of vertices (corresponding to entities) and a set of edges (corresponding to relationships). When data for a specific application has many relevant relationships, the data may be represented by a graph.

Graph processing systems can be split into two classes: graph analytics and graph querying. Graph analytics systems have a goal of extracting information hidden in the relationships between entities, by iteratively traversing relevant subgraphs or the entire graph. Graph querying systems have a different goal of extracting structural information from the data, by matching patterns on the graph topology.

Graph pattern matching refers to finding subgraphs, in a given directed graph, that are homomorphic to a target pattern. If the target pattern is (a) → (b) → (c) → (a), then corresponding graph walks or paths may include the following vertex sequences:
(1) → (2) → (3) → (1),
(2) → (3) → (1) → (2), and
(3) → (1) → (2) → (3).
One hop corresponds to a graph walk consisting of a single edge. A walk with n edges is considered as a n-hop pattern.

There exist challenges to updating a graph stored in an in-memory graph database or graph processing engine while providing snapshot isolation guarantees and maintaining analytical performance on the graph. For example, most graph processing engines and graph databases use special indices to accelerate the graph traversals when performing graph analytics or answering graph queries. However, it is difficult to modify these data structures to have fast updates while maintaining the performance during graph analytics and querying. Maintaining snapshot isolation — meaning adding the requirement that a user should be able to perform their analytics on a specific version of the graph not affected by concurrent new updates on the graph — provides additional difficulties as well.

Especially problematic is concurrently using multiple versions of a graph. Due to sharing unchanged data between different versions of the graph, non-optimized traversals would be decelerated by repeated data-access indirections to determine the data for a desired version of the graph, and therefore incur performance degradation in analytical workloads such as graph algorithms, graph pattern matching, graph traversing, and graph queries.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 is a block diagram that depicts an example computer that hosts and operates an element iterator, which is fast and memory efficient, that provides access to elements of a graph that has modifications buffered in a delta log.

FIG. 2 is a block diagram that depicts an enhanced reverse compressed sparse row (CSR) structure that is accelerated by an auxiliary data structure (eRevOffset) that is optimized for accommodating topological changes to a graph.

FIG. 3 is a block diagram that depicts example subsequences of nodeIdx for two given vertices.

FIG. 4 is a block diagram that depicts an example edge table that can be segmented in per source-vertex segments for a forward delta CSR and edge properties.

FIG. 5 is a block diagram that depicts logical and physical content of an array with delta logs (delta array).

FIG. 6 is a block diagram that depicts logical and physical content of a list-array with delta logs (delta list array).

FIG. 7 is a block diagram that depicts example bitmaps that track which graph elements were deleted from an example graph.

FIG. 8 is a block diagram that, on the left side, depicts an example graph and, on the right side, depicts an example stack of a stack-based iterator.

FIG. 9 is a flow diagram that depicts an example process that a computer may perform to iterate some or all graph elements (i.e. vertices, edges, or properties) of a graph.

FIG. 10 illustrates a block diagram of a computing device in which the example embodiment(s) of the present invention may be embodiment.

FIG. 11 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are new graph iteration techniques which accelerate analytical workloads on graphs that use delta-logging to achieve fast update. An efficient graph update mechanism (e.g. using delta-logged data structures that record only changes to a graph) is crucial for huge graphs that may contain billions of vertices and trillions of edges. A technical problem is that analysis and mutation may be contradictory design goals for graph processing. Optimizing for mutation may decelerate analysis.

The approach herein enhances the performance of graph traversals that are used for analytical workloads such as graph algorithms or graph queries, even when using data structures that have been specialized for fast graph updates. This makes it possible to perform more complex graph analytics on fast evolving graphs and achieves the best of both worlds: almost fastest read-only performance with support for fastest updates.

Herein are the first-ever implementations of graph iterators that are optimized for graphs using delta-logged data structures. The performance achieved is close to the performance obtainable on read-only graph indices such as compressed sparse row (CSR) and may come within a few percent in runtime on graph traversal-bound algorithms and graphs, which is an order of magnitude faster than other techniques. This approach solves the problem of making graph traversals, such as iterating over the neighbors of a vertex, such as with depth first search (DFS) or breadth first search (BFS) traversals, more efficient on graphs which are represented by specialized data structures for fast graph updates.

Fast graph updates can be achieved by using delta-logged data structures in which non-changing information between different versions of the graph is shared as much as possible, but at the expense of added indirections and thus added latency during analysis. Herein are a set of graph iterators that avoid indirections to graph data by leveraging the graph access patterns, especially spatial and temporal locality that can be provided by those patterns.

Graph iterators herein amortize all indirections incurred by the underlying representation by leveraging the following attributes of graph traversal patterns.
spatial locality: for traversal patterns such as vertex traversals, neighbor traversals, BFS, operations are amortized across contiguous range of vertices of edges;
recursion: for traversal patterns such as DFS which are recursive, a DFS iterator stores additional state in stack data structures so that fast traversal can be achieved during the backtracking phases of the traversal.

Some of these iterators are specialized for the following important use cases. Direct property iterators can be used when the properties are known to have been created for the current snapshot (i.e. version) of the graph and, in this case, the checks in the delta-logs can be omitted. Those direct iterators can be pervasively used in graph algorithms generated by a graph algorithm compiler, and can be automatically selected by the compiler.

Full-range iterators and property iterators can be used when it is known that the iteration over a range of vertices, neighbors of vertices, or associated properties will be done to completion due to the absence of iteration-breakers (break statements, if statements). These iterators use software prefetching/caching techniques to lower the access costs further. These iterators can be automatically chosen by the graph algorithm compiler.

These techniques may leverage some additional data structures such as bit sets and graph element subsets to avoid work for specific vertices/edges and instead do collective checks for groups of vertices/edges. That helps further decrease memory bandwidth demand and computation overheads of graph traversals.

In an embodiment, a computer generates an element iterator that is based on a graph that contains many elements (e.g. vertices, edges, and their properties) and a delta log that represents topological modification(s) of the graph. The delta log only records changes, such that some graph elements are modified and occur in the delta log, and other graph elements are unmodified and are absent from the delta log. Thus, iteration of some graph elements may need to retrieve data from the delta log, but iteration of other graph elements may instead retrieve data directly from the graph itself and not from the delta log. Based on the element iterator and the delta log, a first graph element is accessed during iteration. Based on the element iterator but not the delta log, a second graph element is accessed. For example, a result may be generated that is based on the first element and the second element that were iterated based on different respective data structures.

### Heterogeneous In-Memory Graph

A heterogeneous in-memory graph, which is also referred to as “partitioned in-memory graph,” includes one or several vertex tables and edge tables. Each of these tables includes vertices or edges of a certain type with specific sets of properties to each table. A single edge table connects edges between source and destination vertices with the constraints that the source vertices all come from a specific source vertex table and/or that the destination vertices all come from a specific destination vertex table.

Vertex Tables. A vertex table contains vertices of a specific type. For example, a vertex table may hold vertices that represent people and have properties such as FirstName, LastName, Address, etc. Users may decide to split vertex tables further, for example, by having one vertex table representing persons born in the month of September, one for persons born in October, etc. In each vertex table, the vertices are stored in a columnar-fashion (e.g., each vertex property being in a separate array).

A vertex key mapping is maintained to associate the user specified key for that vertex to an internal index for that vertex. The index associated with a vertex is a unique numerical identifier, which is referred to as a physical vertex index. Initially, when a table is created, the index is in the range [0,V] where V is the number of vertices during table loading.

In an embodiment, the physical vertex index of valid vertices remains persistent across different snapshots of the graph as long as the vertices are not deleted and can therefore be used as index into properties. Whenever new vertices are added, they may take the place of previously deleted vertex, which is referred to herein as a vertex compensation. A bit array indicates, for each physical vertex index, if the corresponding vertex is deleted in the current snapshot or not. In an embodiment, one such bit array is created per snapshot. Having such physical vertex indices stable across snapshots makes it possible to minimize disruptive changes for the edges.

Edge Tables. An edge table contains edges that are between some source vertices of a specific source vertex table and some destination vertices of a specific destination table. For example, an edge table may hold edges that represent financial transactions between bank accounts and have properties such as Amount, Currency, etc. An edge table has two special columns: a source vertex column (e.g., Source Vertex Id column) and a destination vertex column (e.g., Destination Vertex Id column), which point to the source vertex and the destination vertex of each edge and are foreign keys in the source and destination vertex tables, respectively.

### Example Iterator for Mutable Graph

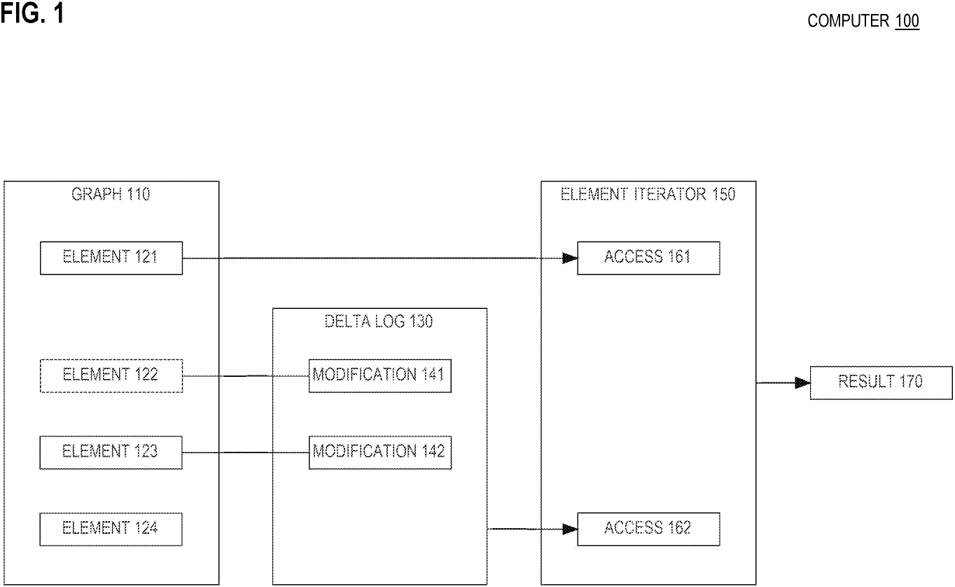

FIG. 1 is a block diagram that depicts example computer 100 that hosts and operates element iterator 150, which is fast and memory efficient, that provides access to elements of a graph that has modifications 141-142 buffered in delta log 130. Computer 100 may be one or more of a rack server such as a blade, a personal computer, a mainframe, a virtual computer, or other computing device.

Graph 110 is a logical graph such as a property graph that is stored in memory such as volatile random access memory (RAM) in computer 100. Graph 110 contains some or all of elements 121-124 that may each be a vertex, an edge, or a property of a vertex or edge. Each vertex may have zero or more edges, and each edge connects two vertices that are different or are a same vertex. Graph 110 and/or its edges may be directed or undirected. In an embodiment, vertices and/or edges have properties, such as colors and labels, that are or are not treated as graph elements that can be iterated by element iterator 150 and/or can be recorded in delta log 130.

The topology of graph 110 is mutable such that vertices and edges can be added and removed from graph 110. Additions and removals of elements of graph 110 are accumulated in delta log 130 as modifications 141-142. Each of modifications 141-142 tracks removal or addition of one graph element. In an embodiment, change delta log 130 stores only topological modifications but not property modifications. In various embodiments, modification 141 may be an insertion or removal of an edge or vertex, which changes the count of elements in graph 110, but cannot be a reassignment of a new value to an old property of an edge or vertex, and can or cannot be an assignment of a new property of an edge or vertex.

For example, graph 110 may initially contain only elements 121-122 and 124. When element 122 is removed as drawn with a dashed outline, modification 141 is appended onto delta log 130. When element 123 is inserted into graph 110, modification 142 is appended onto delta log 130. Thus, delta log 130 accumulates a sequence of modifications of graph 110. Delta log 130 is a dense structure such that graph 110 may contain billions of vertices and trillions of edges, but delta log 130 contains only information about graph elements that changed. If graph 110 is unchanged, then delta log 130 is empty or non-existent.

Thus, accessing current contents of graph 110 may entail inspecting delta log 130. In an embodiment and although not shown, an earlier version of graph 110 may be stored in memory as base data structure(s). In various embodiments, the base data structure is or is not read only. In various embodiments, if delta log 130 exists and is not empty, then the base data structure is or is not inconsistent without delta log 130.

For example, the base data structure may contain offsets into a table or array of graph elements, and insertion of new element 123 may change and/or invalidate, in the table or array, the offset of preexisting element 124, such as by shifting element 124 within the table or array. If the base data structure becomes inconsistent, it may still be used to access some elements but not others. In an embodiment, inspection of delta log 130 is needed to determine which elements are still directly usable in the base data structure.

In an embodiment, contents of delta log 130 may eventually be incorporated into the base data structure by a process presented later herein as consolidation. For example, contents of the base data structure and contents of delta log 130 may be consolidated to populate a new version of the base data structure, after which delta log 130 may be emptied or discarded and the old base data structure may or may not be discarded. In an embodiment, old base data structures and/or old delta logs are retained to provide access to historical versions of graph 110. For example, different clients may concurrently access different respective versions of graph 110.

As discussed above, a two-dimensional logical table such as a vertex (or edge) table may be horizontally sliced into partitions containing subsets of vertices and/or vertically sliced into vectors containing subsets of properties. In an embodiment, each slice has its own base data structure(s) and its own delta log(s). Thus, one version of one graph may have many delta logs.

Execution of graph analytics or a graph query for graph 110 may be based on delta log 130. For example, a graph query may access some graph elements directly in the base data structure and access some other graph elements by inspecting delta log 130. In other words and depending on which elements, accessing multiple elements may entail alternating between using delta log 130 and the base data structure, which may have discrepant application program interfaces (APIs). Element iterator 150 encapsulates such diversity of access mechanisms/interfaces by providing a uniform interface that can be used to access all elements of graph 110 regardless of whether or not the topology of graph 110 has changed.

Element iterator 150 enumerates elements of graph 110. For example, element iterator 150 can provide access to each element, one by one, as a sequence of elements. In an embodiment, element iterator 150 provides access to an element by providing a reference, such as a memory pointer, to the element. In an embodiment, element iterator 150 provides access to an element by providing an identifier, key, or offset of the element, which can be subsequently used to randomly access the element in an aggregation of elements such as a table, vector, or array in memory.

In an embodiment, vertices of graph 110 are identified by a range of unsigned integers and/or edges of graph 110 are identified by a range of unsigned integers. The integers may be offsets into a table, vector, or array in memory. In an embodiment, element iterator 150 iterates only graph elements whose offsets/identifiers are in a specified subrange. For example, element iterator 150 may iterate only over a particular segment of a segmented array of graph elements. Segments are discussed later herein.

In various embodiments, element iterator 150 may iterate one of the following sets of graph elements.
respective values of a particular property for vertices in the graph,
respective values of a particular property for edges in the graph,
neighbor vertices that are connected by respective edges to a particular vertex in the graph,
all vertices of a graph component that is the graph itself or a connected subgraph of the graph, or
all edges of a graph component that is the graph itself, a connected subgraph of the graph, or a vertex.

In an embodiment, a forward element iterator and a reverse element iterator may iterate a same set of graph elements, but in opposite orderings (i.e. forward and reverse). For example, the two iterators may respectively use a forward compressed sparse row (CSR) and a reverse CSR as discussed later herein. For example, the base data structure may contain a forward and/or reverse CSR.

In various embodiments, element iterator 150 may iterate graph elements in an ordering that is different from the ordering in which the graph elements are stored in memory. For example, element iterator 150 may be a queueing iterator that is based on a queue of (e.g. distinct or non-distinct) graph elements. Logic that uses element iterator 150 may append graph elements onto one end of the queue, and element iterator 150 may, in a first in first out (FIFO) manner, remove graph elements from the other end of the queue. In an embodiment, the queue is a priority queue. In various embodiments, appending and removal occur in a same execution thread or in respective different threads.

In an embodiment, a stack is used instead of a queue and operated in a last in first out (LIFO) manner. For example, element iterator 150 and the stack may be used to iterate graph elements in a depth first search (DFS) ordering. Stacked based iteration is discussed later herein.

In various embodiments, multiple element iterators are composable, cooperative, or can be orchestrated. For example, a neighbor iterator may, based on a particular vertex, iterate neighbor vertices that are connected to the particular vertex by respective edges. A vertex dequeued by a queuing iterator may be used as the particular vertex of the neighbor iterator, and neighbors iterated by the neighbor iterator may be appended onto the queue of the queuing iterator thereby implementing a breadth first search (BFS) ordering of iteration based on two element iterators.

In various embodiments, element iterator 150 is optimized for speed even though additional logic or special hardware may be needed. For example even though element iterator 150 provides access to only one graph element at a time, element iterator 150 may prefetch multiple graph elements that could be iterated soon. For example, element iterator 150 may prefetch a next segment of graph elements. Segments are discussed later herein.

Prefetching entails copying multiple graph elements from main memory into a (e.g. level 1-3, L1-L3) hardware cache of a central processing unit (CPU). Depending on the embodiment, prefetching occurs in the foreground (i.e. same thread as iteration) or in the background (i.e. different thread than iteration). In an embodiment, prefetching uses a special instruction of an instruction set architecture (ISA).

In an embodiment, element iterator 150 accelerates by using single instruction multiple data (SIMD) to concurrently process multiple graph elements. For example as discussed earlier herein, element iterator 150 may use delta log 130 and/or the base data structure in ways that are based on repeating a sequence of CPU instructions for each of multiple graph elements. When SIMD is included in the sequence of CPU instructions, repetition of some or all of the sequence of CPU instructions is unneeded to process the multiple graph elements. For example, SIMD may be included in a sequence of CPU instructions that is faster and denser (i.e. less cache thrashing) than loop unrolling.

As discussed earlier herein, graph elements may have properties that are stored in respective columns of a two-dimensional table whose rows respectively correspond to the graph elements. The two-dimensional table may be a logical structure that is not entirely stored in contiguous memory. For example, the two-dimensional table may be logically partitioned into horizontal slices that store a subset of graph elements or into vertical slices that store a subset of properties for all graph elements. Such slices may or may not be implementations of segments as discussed later herein.

In an embodiment, slices complement the base data structure by factoring element properties out of the base data structure. In an embodiment, the base data structure is stored in a managed heap and the slices are instead stored outside of the heap in unmanaged memory. For example, a Java virtual machine (JVM) may manage the heap in memory. In an embodiment, element iterator 150 uses an unsafe API to access data such as slices in unmanaged memory such as with field and array accessors in class sun.misc.Unsafe in Java 8 that are faster than using ordinary object accessors that are burdened by overhead of checking type safety or index range boundaries.

In an embodiment, two clients may share a same version of graph 110, and one of the clients may use element iterator 150 to safely access elements of graph 110 while the other client concurrently changes the topology of graph 110. In an embodiment, a client may change the topology of graph 110 while the client uses element iterator 150 to safely access elements of graph 110. In an embodiment, element iterator 150 can be used to safely change the topology of graph 110 during iteration, such as deletion of a current element of element iterator 150. In any case, graph analysis or a graph query may cause computer 100 to generate result 170 that is based on multiple graph elements of graph 110 as accessed through element iterator 150. For example, result 170 may be a partial or complete answer to a graph query.

### Example Vertex Range Iterator

A vertex array has a range of vertex offsets. A vertex range iterator iterates over a subrange of vertices. As discussed elsewhere herein, neighbor vertices of a given vertex may correspond to a subrange of edges in an edge array. In any case, the vertex range iterator implements the following methods.
setVertexRange(int vertexIdStart, int vertexld): sets the current vertex range to iterate over. In order to accommodate initialization logic that is common across all possible vertex ranges (e.g. unwrapping/casting arrays to a specific type), the vertex range iterator is allocated once per execution thread per usage location and reassigned to the current vertex range for each new traversal. An operand stack of a Java virtual machine (JVM) or a Java ThreadLocal may be used to provide a vertex range iterator per thread.
nextVertex(): moves the iterator to the next vertex, returns false if there are no more vertices.

### Example Property Iterator and Orchestration of Multiple Iterators

As discussed earlier and later herein, multiple element iterators may cooperate, be nested, and/or be orchestrated. When traversing a vertex range, a goal may be to access associated vertex properties. In order to do that, a property iterator is used in combination with a vertex range iterator. The property iterator has references to the vertex range iterator and to the delta log (e.g. delta-array discussed later herein) containing the vertex property values. To access vertex properties via the property iterator, the method get() can be called as presented later herein.

The following example shows how to query a vertex property while iterating over all vertices of a graph.

RangeIterator rangeIter = new RangeIterator();
PropertyIterator propIter = new PropertyIterator(doubleProperty,
rangeIter) ;
rangeIter.setVertexRange(0, V); /* V == number
of valid and deleted vertices in graph */
while (rangeIter.nextVertex()) {
} double propertyValue = propIter.get();

Internally, the vertex range iterator keeps track of the current vertex index. As discussed later herein, a bitmask may determine which vertices have been deleted and need therefore to be skipped during the iteration.

There is no argument to the get() method of the range iterator to specify from which vertex to read the property. Instead, the property iterator queries the index directly from the range iterator. Checking the bitmask for invalid indices (deleted vertices) and adjusting the index is therefore not required in the property iterator.

The following code snippet shows how the property iterator queries the state (i.e. traversal context) of the vertex range iterator and checks if there are delta logs for that specific property and returns the property value.

public double get() {
int idx = rangeIter.getCurrentVertex();
/* return value from delta-log if
present, otherwise fall back on base
array */
if (deltaLog != null &&
deltaLog.containsKey(idx)) {
return deltaLog.get(idx); }
return baseArray.get(idx); }

The following example shows a graph query written in property graph query language (PGQL) that iterates over all vertices “v” and accesses the vertex properties “FirstName”, “LastName” and “Age”.

SELECT v.FirstName, v.LastName, v.Age MATCH (v)

To execute the above query, a query plan may be generated that has three property iterators that access the current vertex index directly from the query plan’s range iterator which could be used to traverse all vertices (MATCH (v)) in order to access values for the “FirstName”, “LastName” and “Age” properties. Each property iterator needs to individually check for delta logs because not all properties might be updated simultaneously, resulting in a situation where some values are in the delta logs and some are instead in the base array for the same vertex.

### Example Representation of a Graph in Memory

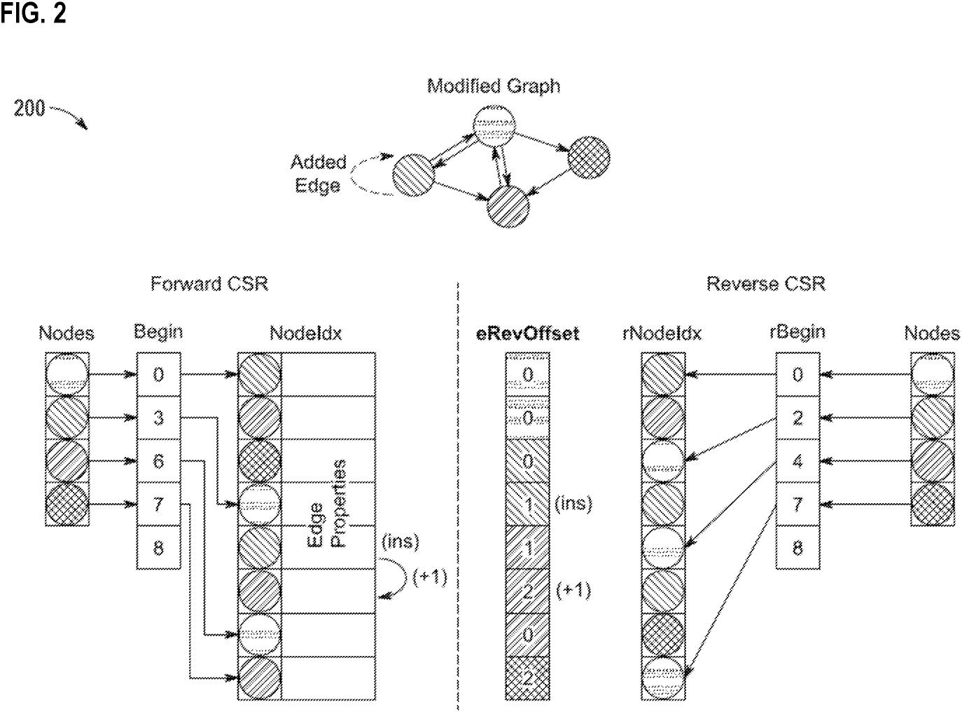

FIGS. 2 and 4-6 illustrate techniques for storing and operating base data structures and delta logs of a graph in reusable ways that do not depend on an element iterator but that can facilitate implementing an element iterator as discussed herein. Various embodiments of a graph iterator may use various combinations of those techniques for iterating elements of a graph. Additional techniques for storing and operating base data structures and delta logs of a graph are presented in related U.S. Pat. Application 17/194,165.

In an embodiment, a graph may be represented by compressed sparse rows (CSR). An example CSR is presented later herein for FIG. 2. In a CSR index, edges are represented with arrays: a begin array and a node index array. The begin array lists, for each source vertex physical index, the start index of a “source vertex” edge list of that source vertex in the node index array. The node index array stores, for each edge index, the physical vertex index of the destination vertex. Edges are grouped by source vertex physical index. Additionally, they are sorted based on the physical index of the destination vertices. The contiguous segment of destination vertices belonging to the same source vertex is referred to as an edge list. The position of the edge in the node index array to be the edge index is considered. Grouping edges by source vertex into contiguous edge lists allows for efficient traversal of all outgoing edges of a given vertex. The position of the edge in the node index array is referred to as edge index.

In addition to this “forward” or “direct” CSR that represents the directed edges from source vertex to destination vertex tables, a “reverse” CSR may be generated. An example reverse CSR is presented later herein for FIG. 2. The reverse CSR represents the same edges as the forward CSR but in reverse direction. Analogous to the forward CSR, edges are grouped into contiguous edge lists based on their destination vertex. The reverse CSR ensures efficient traversal of incoming edges given a destination vertex. In an embodiment, edge properties are stored according to the forward CSR and not duplicated in the reverse direction. Therefore, edge properties can directly be accessed via forward edge indices.

Since edges are ordered in a different way in the reverse CSR representation, an auxiliary data structure translates reverse edge indices to the edge indices of the forward CSR. In this manner, it is possible to access edge properties when iterating over the reverse CSR representation.

In an embodiment, an example bidirectional CSR representation contains absolute indices of graph elements. An example bidirectional CSR is presented later herein for FIG. 2. The bi-directional CSR representation includes a forward CSR, a reverse CSR, and an auxiliary data structure (eRev2Idx) storing absolute indices for the graph. The forward CSR includes a begin array (Begin) and a node index (NodeIdx) array. The reverse CSR includes a begin array (rBegin) and a node index (rNodeIdx) array. The eRev2Idx array translates reverse edge indices to the edge indices of the forward CSR. For example, eRev2Idx[0], corresponding to rNodeIdx[0], may include 3, which is used as an index into the NodeIdx array to access edge properties.

### Delta Csr

Since edge properties are only stored along the forward direction, it may be necessary to determine to which forward edge a reverse edge corresponds to, e.g. to be able to access edge properties when traversing edges from the reverse direction. As described above, an auxiliary data structure (eRev2Idx) may be used to associate or map each reverse edge index with its forward edge index. A reverse edge index would be translated to a forward edge index according to this array and then used to access edge properties. Table 1 illustrates pseudo code of using absolute indices to access edge properties.

TABLE 1

long forwardEdgeIndex = eRev2Idx[reverseEdgeIndex];
// perform edge property access
double forwardEdgePropertyValue = edgeProperty[forwardEdgeIndex];

With such a mapping, edge insertions or deletions in the forward direction may provoke large disruptions. For example, if an edge is added to the first vertex index, the entire content of eRev2Idx must be incremented by 1, as further described below.

FIG. 2 is a block diagram that depicts an enhanced reverse CSR structure that is accelerated by an auxiliary data structure (eRevOffset) that is optimized for accommodating topological changes to the shown graph.

Rather than storing the eRev2Idx mapping, forward edge offsets are stored in the shown eRevOffset array and the actual forward edge index (for example, when an edge property has to be accessed) is computed whenever needed at run-time. Table 2 illustrates pseudo code of using offset to access edge property.

TABLE 2

int srcVertexIdx = rNodeIdx[reverseEdgeIdx];
long forwardEdgeIndex = begin[srcVertexIdx] +
eRevOffset[reverseEdgeIdx];
// perform edge property access
double forwardEdgePropertyValue = edgeProperty[forwardEdgeIndex];

By using offsets instead of absolute indices, edge additions or deletions become less disruptive: the begin array is modified as part of updating the forward CSR, and the eRevOffset array is modified in much fewer places. The places where eRevOffset has to be modified due to the addition or deletion of edges are referred herein to as damages.

An additional advantage of the eRevOffset array is that it stores small values that can be efficiently compressed, for example using a variant encoding, or that it uses a smaller datatype than would be necessary for the eRev2Idx array.

FIG. 2 illustrates an example bidirectional CSR representation contains offsets of graph 200. The bi-directional CSR representation includes a forward CSR, a reverse CSR, and an auxiliary data structure (eRevOffset) storing offsets for the graph. The forward CSR includes a begin array (Begin) and a node index (NodeIdx) array. The reverse CSR includes a reverse begin array (rBegin) and a reverse node index (rNodeIdx) array. The eRevOffset array stores edge offsets. For example, eRevOffset [0], corresponding to rNodeIdx[0], may include 0, which is used as an offset into the NodeIdx array to access edge properties (e.g., nodeIdx[begin[1] + offset of 0]). For another example, eRevOffset [6], corresponding to rNodeIdx[6], may include 2, which is used as an offset into the nodeIdx array to access edge properties (e.g., nodeldx[begin[0] + offset of 2]). The forward CSR and reverse CSR of the bi-directional CSR representation with offsets are referred herein to as forward delta CSR and reverse delta CSR, respectively.

### Modifications to the Offset Auxiliary Data Structure

Since edge lists are kept sorted in the forward and reverse CSR, an edge insertion or removal may happen at any place in the forward edge list. The edges after that insertion/deletion location have therefore a different edge offset by the end of the graph update (except if another edge deletion or insertion compensates that change of offset overall). This change of edge offset must be reflected in the eRevOffset array.

FIG. 2 illustrates an example diagram 200 depicting how the eRevOffset would be modified due to an edge insertion. In the modified graph shown in FIG. 2, an edge is added. An edge is added to each of the nodeIdx and eRevOffset arrays, and one (1) impacted entry in eRevOffset array are incremented by 1.

As illustrated in FIG. 2, there are much fewer entries to be modified in the eRevOffset array as the impact of the insertion is limited to the edges that have the same source vertex and are located after the inserted edge. Damages are limited in scope.

From a mathematical standpoint, an edge insertion provokes in the worst case the total modification of the eRev2Idx array which is an O(E) operation, where E is the number of edges, while an edge insertion can only provoke in the worst case as many modifications in eRevOffset array as the maximum out-degree of a vertex, O(Max({out_degree(v), for v in V})).

### Example Common Neighbor Iterator

As shown in FIG. 2, the nodeIdx array is an array of edges that is primarily sorted by the source vertex of each edge and secondarily sorted by the destination vertex of each edge. A neighbor iterator that iterates edges of a given vertex, or iterates neighboring vertices connected by those edges, may use the begin array to discover: a) where within the nodeIdx array to seek to for starting iteration and b) how many edges/neighbors to iterate. Thus, the edges that originate at a same source vertex are a contiguously stored subsequence within nodeIdx. That subsequence of edges is sorted by destination vertex, which is the vertex at which an edge terminates.

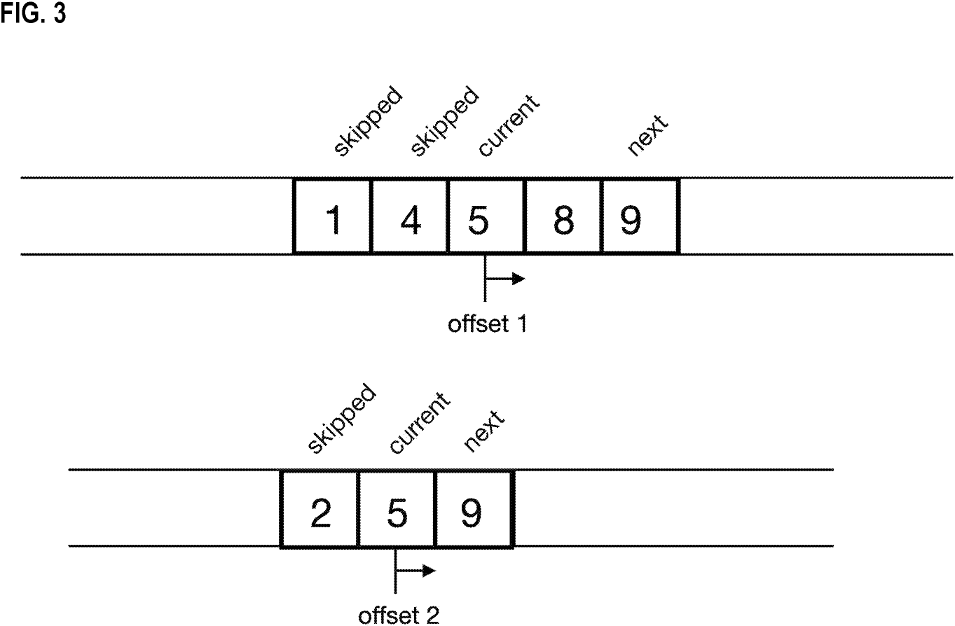

A category of graph traversal algorithms are based on iterating vertices that are shared as common neighbors by two given vertices. FIG. 3 is a block diagram that depicts example subsequences of nodeIdx for two given vertices. A common neighbor iterator (not shown) uses the two shown subsequences to iterate, at maximum speed, only vertices that are common neighbors of both of the two given vertices. That is, the common neighbor iterator iterates vertices that terminate a respective edge of each of the two given vertices.

The common neighbor iterator traverses both shown subsequences from left to right. The numbers shown within the subsequences are identifiers (e.g. offsets into a vertex array, not shown) of neighbor vertices. Thus as shown, the first neighbor in the top subsequence is vertex 1, and the first neighbor in the bottom subsequence is vertex 2. Because the subsequence are sorted by vertex, it is guaranteed that, because the bottom subsequence starts with vertex 2, the bottom subsequence does not contain vertex 1. Thus, vertex 1 cannot be a common neighbor, which is why vertex 1 is skipped by the common vertex iterator as shown.

The common vertex iterator contains shown offsets 1-2 that indicate which vertex is the respective currently iterated vertex in the two respective subsequences. Skipping a vertex in one subsequence entails incrementing the subsequence’s offset by one. Only one of offsets 1-2 is incremented when a vertex is skipped. The common vertex iterator does not provide access to skipped vertices.

In the top subsequence, skipped vertex 1 is followed by vertex 4 as shown. Because vertex 4 (in the top subsequence) logically would sort after vertex 2 (in the bottom subsequence), the top subsequence cannot contain vertex 2. Thus, vertex 2 is skipped in the bottom subsequence as shown, which causes offset 2 to advance to make vertex 5 the current vertex in the bottom subsequence as shown. Because vertex 5 would sort after vertex 4, vertex 4 is skipped as shown, which causes offset 1 to advance to make vertex 5 the current vertex in the top subsequence as shown.

Thus as shown, both subsequences have vertex 5 as a same current vertex, which means that vertex 5 is a common neighbor that is accessible during iteration and not skipped. Unlike skipping that advances only one of offsets 1-2, accessing a common vertex causes both offsets 1-2 to be incremented by one. Eventually, the next common neighbor is vertex 9 as shown.

### Delta Data Structures

In an embodiment, one or more data structures used in vertex and edge tables are modified to become delta data structures. Delta data structures store information in a base data structure (also referred herein to as a consolidated version of the data structure) and changes in delta logs.

When a delta log becomes too large for a delta data structure (e.g., according to a threshold considering the size of the consolidated version), a consolidation/compaction operation can be triggered, which merges content of the delta log in a new consolidated version of the delta data structure.

Data structures used in vertex and edge tables may be segmented. Segmenting the data structures used in the vertex and edge tables presents many advantages, including localizing the updates to a reduced portion of a vertex or edge table and enabling sharing data at a finer level between graph snapshots. Additionally, “normal” data structures can be used for unmodified segments to reduce overhead for analytical workloads.

### Segmentation

In an embodiment, segmentation is used for different data structures. Segmentation schemes may be different for vertex and edge tables.

Vertex Table Segmentation. Each vertex table can receive modifications independently of the other tables and can therefore be segmented independently from the other tables. Inside a vertex table, a simple scheme which segments according to a fixed chosen size may be adopted, or a certain segment size may be selected to guarantee a certain number of segments. All properties associated with the vertex table follow the same segmentation scheme.

Between graph snapshots, it is possible to share data at segment granularity to maximize memory sharing, according to an embodiment.

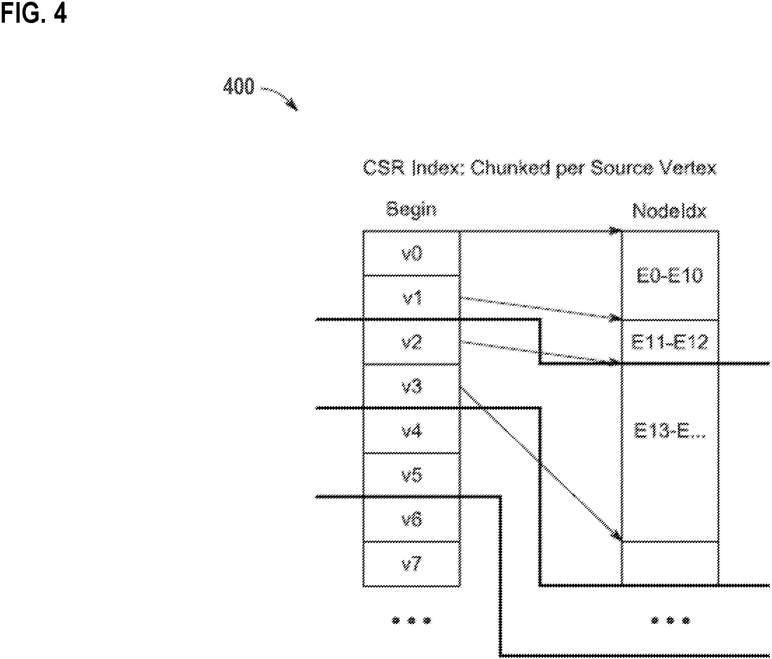

Edge Table Segmentation. In edge tables, edges are grouped by source vertices for the forward index and according to the destination vertex for the reverse index. Edge tables can be segmented in per source-vertex segments for the forward delta CSR and edge properties, as illustrated in an example block diagram 400 of FIG. 4. Similarly, edge tables can be segments in per destination-vertex segments for the reverse delta CSR and eRevOffset array.

Segmentation may be based on a fixed number of edges instead of per vertex. However, in some scenarios, this may not be desirable because adding an edge to a specific segment would require remaking segments, as ordered in the array of consolidated lists, to ensure the desired segment size.

### Reference Counting

Consolidated data segments and logs of each delta data structure can be shared between graphs. If a segment has no modifications at all between one version and the next, both the consolidated data array and the delta logs can be reused. If modifications were performed, the consolidated array can be reused but the delta logs will differ. In an embodiment, to keep track of the number of snapshots that use each base segment (respective log segment), a reference counter may be used at a data segment (respective log segment) scope. When a data segment (respective log segment) is not used anymore (e.g., reference counter going to 0), it is deallocated.

### Data Structure Details

Techniques described herein use specialized data structures. The following discusses their uses cases in vertex and edge tables.

(Segmented) Arrays with Delta Logs. An array with delta logs includes two components:
Array of consolidated values: A consolidated array is an array in memory that contains values at a base version.
Delta log: A delta log is a sparse mapping (e.g., hash map) containing the changes, e.g., modified or added values, compared to the array of consolidated values.

Changes to the array with delta logs are put into the delta log without modifying the array of consolidated values.

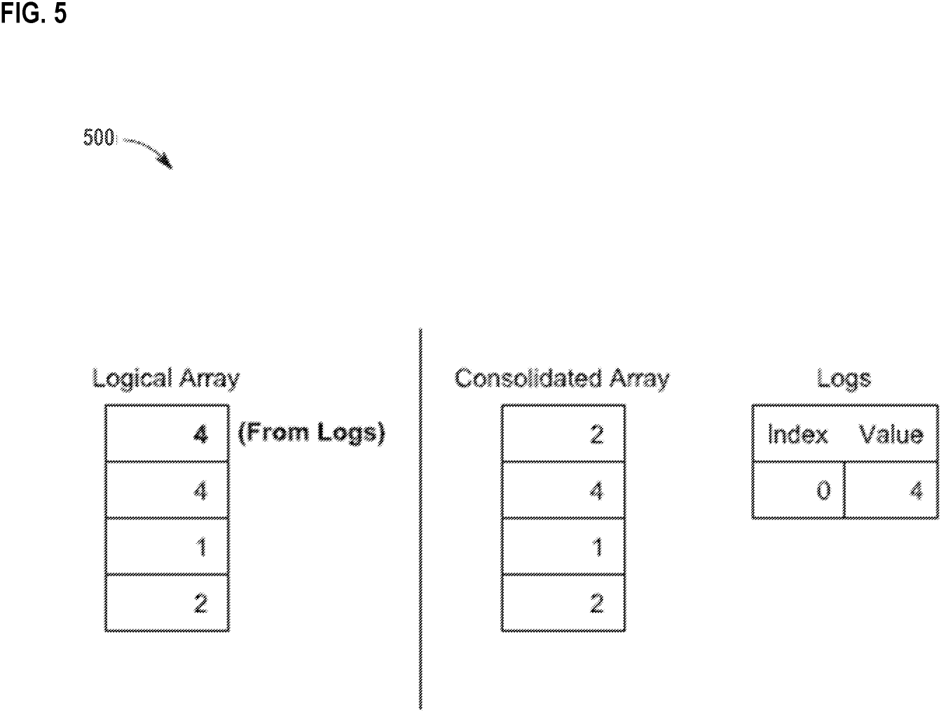

FIG. 5 illustrates an example block diagram 500 of logical and physical content of an array with delta logs (delta array). Conceptually, to access a value at a specific index, it is first checked to see if the delta log has an entry for that value. If that is the case, the value will be returned from the delta log; otherwise, the value will be returned from the consolidated array.

For example, since the delta log (labeled as logs in FIG. 5) has an entry for index 0 of the logical array, the corresponding value 4 is returned. For another example, since the delta log does not have an entry for index 1 of the logical array, the value 4 at index 1 of the consolidated array is returned.

In an embodiment, when the delta log becomes too large, according to some threshold considering the size of the array of consolidated values, a consolidation operation is triggered, and content of the delta log is merged in a new consolidated array.

In an embodiment, both the consolidated array and the delta log can also be segmented so as to limit the scope of the consolidation operations to segments. It may be beneficial for graphs with skewed distributions where changes will frequently affect the same “supernodes,” which will be in only a few segments if the segment size is chosen correctly.

Reference counters associated with the segments of the array of consolidated values and of the delta log are used to determine when memory de-allocation is possible (e.g., when the reference counter becomes zero).

(Segmented) List-Arrays with Delta Logs. A list-array is an array in which each cell (indexed by a list index) contains a list of variable size. A list-array with delta logs includes three components:
Array of consolidated lists: An array of consolidated lists stores consecutively contents of lists.
Array of consolidated list begins: An array of consolidated list begins is a lookup array that stores for each list index the start index of the corresponding list in the array of consolidated lists.
List delta log
   Delta lists: An array stores the content of the modified or newly added lists.
   List positions: A sparse mapping where the key corresponds to a list index of the list-array and the value is the bitwise concatenation of the start index of the corresponding list in the delta lists array and the length of the list.

While the array of consolidated lists can be viewed to contain lists at a base version, the list delta log contains lists that have been modified or added compared to the base version. A list is modified if values in that list are modified, removed, or added. Similar to arrays with delta logs, the consolidated arrays are not modified when a change is added to the delta log.

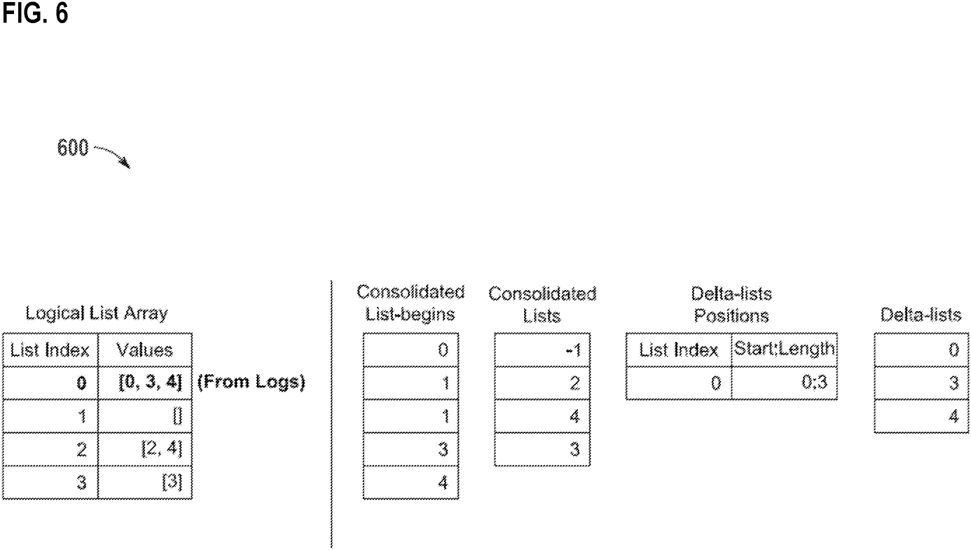

FIG. 6 illustrates an example block diagram 600 of logical and physical content of a list-array with delta logs (delta list array). To access a list with a specific list index, it is first checked to see if the delta log has an entry for that value. This can be achieved by querying the list starts hash map. If the delta log contains a list for list index, it is accessed from the delta log; otherwise, it is accessed from the array of consolidated lists.

For example, since the delta lists positions array (labeled as Delta-lists Positions in FIG. 6) includes an entry for index 0 of the logical list-array, a list of [0, 3, 4] is returned by accessing the delta lists starting at index 0 to index 2 (total length of 3 as indicated in the delta lists positions). As an illustration, before graph changes, vertex 0 had one neighbor (corresponding to 1 edge, namely edge -1). After graph changes, vertex 0 has 3 neighbors (corresponding to 3 edges, namely edge 0, edge 3, edge 4).

For another example, since the delta lists positions does not have an entry for index 3 of the logical array, a list of [3] is returned by referring to the array of consolidated list begins at index [3] (e.g., having value 3) and index [4] (e.g., having value 4) to determine that one (1) value (e.g., 4-3=1) is to be accessed from the array of consolidated lists at index [3].

For yet another example, since the delta lists positions does not have an entry for index 2 of the logical array, a list of [2, 4] is returned by referring to the array of consolidated list begins at index [2] (e.g., having value 1) and index [3] (e.g., having value 3) to determine that two (2) values (e.g., 3-1=2) are to be accessed from the array of consolidated lists starting at index [1].

For yet another example, since the delta lists positions does not have an entry for index 1 of the logical array, no list is returned by referring to the array of consolidated list at index [1] (e.g., having value 1) and index [2] (e.g., having value 1) to determine that no values (e.g., 1-1=0) are to be accessed from the array of consolidated lists.

In an embodiment, when the list delta log becomes too large, according to some threshold considering the size of the array of consolidated lists, a consolidation operation is triggered, and content of the list delta log is merged in a new consolidated list array.

In an embodiment, both the consolidated list array and the list delta log can also be segmented, according to the list index, so as to limit the scope of the consolidation operations to segments. It may be especially beneficial for graphs with skewed distributions where changes will frequently affect the lists of the same “supernodes,” which will be in only a few segments if the segment size is chosen correctly.

(Segmented) Block-Arrays with Delta Logs. A block-array with delta logs is a special array with delta logs that instead of storing a single value in a cell, stores a fixed sized block of data. For example, instead of having a single integer per cell, if the block size is 64, 64 values would be stored per cell. Such arrays are segmented and subject to consolidation like the other arrays.

(Segmented) Dictionary with Delta Logs. A dictionary is a bidirectional mapping that associates to a key a numerical code. The dictionary with delta logs includes two components:
Mapping from keys to codes
   Consolidated mapping from keys to codes: A mapping (e.g., hash map) from keys to codes.
   Delta mapping from keys to codes: A mapping (e.g., hash map) that contains the changes, for example, added key-code pairs or deletions (potentially stored by mapping the deleted key to a special invalid code).
Mapping from codes to keys
   Consolidated mapping of codes to keys (for reverse lookup): A mapping from codes to keys. As the code space can be chosen as dense, it can be an array, in an embodiment.
   Delta mapping of codes to keys: A mapping (e.g., hash map) that contains the changes of codes to keys.

The consolidated mappings of the dictionary can be viewed as the dictionary for a certain base version. The delta mappings contain the changes with respect to the original version.

To get the code associated to a key, the delta dictionary is first probed. If no mapping is present for the required key (not even the invalid code value indicating a deletion), then the consolidated dictionary is probed. Consolidation and segmentation can be used for the delta mappings from keys to codes and codes to keys.

Delta Data Structures used in Vertex Tables. A bit array is used to indicate, for each physical vertex index, if the vertex is valid or deleted. This bit array can be backed by a full array or, if there are few deletions (common case), by a sparse bitset (not allocating any memory for blocks containing only valid vertices).

For vertex tables, each property is backed by dedicated arrays with delta logs. The vertex key mapping, which provides a mapping from user defined vertex keys to internal vertex index, is backed by a dictionary with delta logs.

Some additional caches, such as arrays, caching the in-degree or out-degree of vertices are also backed by arrays with delta logs.

Delta Data Structures used in Edge Tables. For each edge table, each edge property is backed by dedicated list-arrays with delta logs. The node index arrays of the forward and reverse CSRs are also backed by individual list-arrays with delta logs. If present, an edge key mapping providing a mapping from user defined edge keys to internal edge index is backed by a list-array with delta logs.

The begin arrays of the forward and reverse delta CSRs being monotonically increasing, can be encoded using a checkpoint array (a full array) and a difference array (backed block-array with delta logs). By having this encoding, even if the checkpoint array needs to be completely recomputed from one version of the graph to the next if there are edge additions or removals, it is a much smaller array than the full begin array of the normal CSR (e.g., if the block size is 64, it is 64 times smaller). The array of differences can be mostly re-used as is between versions of the graphs as adding or removing edges only change the differences of a given block (localized changes). The changes to the difference array are put in logs. This encoding is leveraged in the update of the begin array, which is further discussed below regarding the update algorithm of edge tables. Table 3 shows a pseudo code of such an encoding.

TABLE 3

// original monotonic and increasing array
long array[L] = {0, 2, 5, 7, 8, 9, 10}
// array of differences to the checkpointed values
// (in practice, stored in a block-array with delta-logs)
long diffs[L] = {0, 2, 5, 7, 0, 1, 2}
// checkpointed values: store every 4 values of the original array
// (4 is the “block size”, can be changed to any arbitrary value,
// in practice a power of 2 is often used, e.g. 64)
long checkpoints[L/4] = {0, 8}
--
// the following equality holds for every index 0<=i<L
// division can be replaced by a bit shift when the block size is a
// power of two
array[i] = checkpoints[i/4] + diffs[i]

### UPDATE ALGORITHM

Applying changes submitted by a user to create a new graph snapshot is performed in several phases.

Pre-processing the changes submitted by the user. Before starting an application of the changes, the changes submitted by the user are validated to check if they are valid or not, using a pre-processing and validation module. Invalid changes, such as removing a non-existing edge, updating a non-existing property, etc., result in either an error being returned or being ignored.

During the validation process, the changes are also converted to a representation that is more suitable for further processing.
Vertex changes are split by target vertex table and, within a target table, indexed by physical vertex index.
Edge changes are split by target edge table.
Modifications on previously existing vertices/edges are annotated with the internal indices of those vertices/edges.
If there are deleted vertices, edge removal changes for all edges associated to those vertices are generated if not present in the edge changes.

Updating vertex tables. Each vertex table is updated independently, given a set of changes provided by the pre-processing and validation module. If there are no changes for a given vertex table, a fast path that only increments the reference counters of all the delta data structures is taken.

If there are changes for a vertex table, they are processed as follows:
1. In a first step, changes are split by change type (vertex addition, deletion, update).
2. If there are deleted vertices in the resulting snapshot, a bit array is allocated, and vertex deletions are indicated by setting the deletion bits.
3. As many vertex additions are transformed into vertex compensations as possible (compensations are possible until there are no deleted vertices indicated by the deleted vertices bit array).
   a. Indices of deleted vertices that can be used for compensation are found using a progressive binary search that first finds the first deleted vertex and then, starting from the next one, finds a second deleted vertex, etc.
   b. For each vertex addition that becomes a vertex compensation, the reused physical vertex index is set in the vertex change object.
4. If there are remaining vertex additions after the compensation procedure, they are assigned new physical vertex indices at the end of the index range (e.g., V+1, V+2, etc., where V is the number of physical vertices in the previous snapshot).
5. Modifications to the vertex key delta dictionary are performed if necessary (e.g., if there are added or removed vertices):
   a. A new delta dictionary is created, initially by copying the previous logs, and referencing the previous consolidated data.
   b. Removed vertices are added in the delta mapping from keys to code by associating an invalid code value to their previous key.
   c. Added and compensated vertices are added in the delta mapping from codes to keys and in the delta mapping from keys to codes.
   d. If some segments of the delta arrays making up the delta dictionary are eligible for consolidation/compaction, they are compacted.
6. Modifications to the vertex properties are performed per property if necessary (e.g., if there are added vertices, removed vertices, or the property is being updated for some vertex):
   a. For each property that does not need to be modified, the backing delta arrays are reused by incrementing their internal reference counters.
   b. For each property that needs to be modified, a new delta array is created, initialized to reference the data segments of the previous version of the delta array. For each segment that needs to be modified, modifications are applied by copying the old log contents if any and applying the required modifications into new logs. If some segments are eligible for consolidation/compaction, they are compacted.

Updating edge tables. Each edge table is updated independently, given a set of changes provided by the pre-processing and validation module. If there are no changes for a given edge table and there are no topological changes to the vertex tables it connects (addition or removal of vertices), a fast path that only increments the reference counters of all the delta data structures is taken.
1. In a first step, source vertex changes (e.g., vertex additions, removals, and compensations) and edge changes are sorted by source vertex, and grouped into list of changes. For a given source vertex, the group of edge changes associated to it is annotated with a value indicating if the source vertex is being added, removed, compensated, or kept as is, and how many changes of each sort (edge additions, removals, modifications) it contains.
2. In a second step, new begin delta arrays of the forward and reverse CSRs are created by incrementing/decrementing counts of edges for each source/destination vertex compared to the previous version of the graph:
   a. A new checkpoint array is created and updated to reflect required changes.
   b. A new difference array (e.g., block delta array) is created, initially referring to the data segments of the previous version of the delta array.
   c. The blocks of the difference array that need to be modified are modified by copying the old log contents if necessary and performing the required modifications in the new block logs.
   d. If needed, compaction/consolidation is performed on those arrays.
3. In a third step, the node index delta arrays of the forward and reverse CSRs are updated by copying and merging the previous logs of those delta arrays with the new topological modifications (e.g., edge insertions and removals).
   a. If needed, compaction/consolidation is performed on those arrays.
   b. During that same step, the damages for the eRevOffset values are gathered as the edge insertion and removal locations are found.
4. In a fourth step, the damages on the eRevOffset array are sorted by destination vertex so that the eRevOffset delta array can be updated. The changes are then applied to the eRevOffset delta array. If needed, compaction/consolidation is performed on this array.
5. In a fifth step, edge properties are modified if needed:
   a. For each property that does not need to be modified, the backing delta arrays are reused by incrementing their internal reference counters.
   b. For each property that needs to be modified, a new delta array is created, initialized to reference the data segments of the previous version of the delta array. For each segment that needs to be modified, modifications are applied by copying the old log contents if any and applying the required modifications into new logs. If some segments are eligible for consolidation/compaction, they are compacted.

Post-update of vertex tables. If some vertex tables have additional indices such as indices maintaining the in-degree and out-degree of vertices, then those indices are updated for each vertex table for which there were edge tables with topological changes (e.g., added or removed edges).

Compaction. Having large delta logs degrades the performance of analytical workloads because accessing values in the delta log introduces an overhead. To mitigate that, an embodiment consolidates the changes of delta-logged (list) segments once the delta-logs reach a predefined threshold into a new delta-logged (list) segment with empty logs.

### Example Neighbor Access with Delta Lists

Several of the delta log structures presented earlier herein are optimized for sparsity and thus only contain data for some graph elements but not all graph elements. Even though the data itself is sparse, the delta log structures internally are densely packed such that physically adjacent data in memory may be logically noncontiguous. For example, two vertices that are stored physically adjacent to each other within a delta list may be logically far separated in a graph and/or in a vertex table. Thus, detecting whether or not a particular vertex is present in a delta log may entail slow seeking or scanning that, for example, may entail inspecting multiple contextually irrelevant vertices in a delta list before: a) encountering the particular vertex in the delta list or, slower yet b) traversing the entire delta list without encountering the particular vertex.

To some extent, seeking and scanning can be avoided by using an associative structure such as a hash map. However increasing structural density of a hash map favors imperfect hashing. If the hashing is imperfect, then accommodating collisions of different graph elements mapping to a same hash bucket may itself introduce seeking or scanning.

As explained earlier herein, a delta log accelerates by deferring or avoiding consolidation that may entail resizing (e.g. entirely reallocating) and repopulating arrays, which are steps with the highest latency. However to avoid the highest latencies, a delta list may incur lesser additional latencies for extra levels of indirection or seeking or scanning. In ways discussed herein, element iterators may be optimized to minimize accessing of delta logs, thereby providing sufficient acceleration to approach the speed of direct access to base data structures (e.g. CSR).

The following is an example element iterator based on delta lists that are explained above. Similar to delta-arrays, when accessing a list, the element iterator first checks if the delta-log contains a list for the current element of the iterator. Specifically, the element iterator checks if the list-index map contains an entry for the delta-list index of the corresponding list. If so, the list is accessed using the delta-lists array and the delta-begin array. If the delta-log does not contain the list, the list is accessed in the base array, using the base begin array.

For the element iterator to access a value in a specific list, a list-offset needs to be provided as well. This list offset is the same if the list is in the base lists array or in the delta-lists array. Based on the following method parameters or internal fields of the element iterator, the following snippet of internal code of a vertex random-access method of the element iterator shows how a neighbor vertex is accessed when a forward CSR is represented using a list array with delta-logs.
base lists array: stores the lists contiguously, each list is associated with a base-list index. The base-list index corresponds to a vertex ID if the list-array is used as a CSR.
base begin array: indicates the start index of each list in the base array delta-log
delta-lists array: similar to the base array, this array stores lists contiguously
list index map: a hash map that maps a base-list index to a delta-list index. The delta-list index can be used to access the delta-begin array.
delta-begin array: indicates the start index of each list in the delta-lists array
vertexIdx identifies which vertex is being randomly accessed
offsetInList ordinally identifies which neighbor vertex (e.g. first, second, third...)

public int get(int vertexIdx, int offsetInList) {
if (deltaLists != null &&
idxToDeltaListMap.containsKey(vertexIdx)) {
/* the neighbor list for
vertexIdx is in the delta-lists
arrayint */ deltaListIndex =
idxToDeltaListMap.get(vertexIdx)
;
int deltaListStart =
deltaListBegin.get(deltaList
Index); return
deltaLists.get(deltaListStar
}t + offsetInList);
// the neighbor list is
in the delta-lists
arrayint listStart =
beginArray.get(vertexId
x); return
lists.get(listStart +
}offsetInLists) ; }

### Example Local Edge Iteration with Delta Lists

A neighbor traversal iterator encapsulates the logic for traversing outgoing or incoming edges and the corresponding neighbor vertices when given a vertex index. An embodiment may differentiate between forward and reverse neighbor iteration because the properties of reverse edges need to be accessed via an eRev2Idx mapping as discussed earlier herein. Forward and reverse neighbor iterators both implement the following two methods.
setCurrentVertex(int vertexId): sets the current vertex and thereby specifies which neighbor list that should be iterated over in a CSR. In order to accommodate initialization logic that is common across all vertices of the graph (e.g. unwrapping/casting arrays to a specific type), the neighbor traversal iterator is allocated once per graph and “moved” (i.e. reassigned) to the current vertex for each new traversal.
nextEdge(): moves the iterator to the next edge, returns false if there are no more edges.

A forward (i.e. for outbound edges by respecting edge direction) neighbor iterator may be implemented as follows. Iterating over the outgoing edges and querying a vertex property of the neighbor vertex or an edge property is an important scenario. Using the forward neighbor iterator, example traversal logic is as follows.

// given is the vertex index idx
NeighborIterator nIter = new NeighborIterator();
PropertyIterator vPropIter = new
PropertyIterator(doubleVertexProperty,
nIter); PropertyIterator ePropIter = new
PropertyIterator(longEdgeProperty, nIter);
/*
traversal
setup*/
nIter.setCu
rrentVertex
(idx);
while (nIter.nextEdge()) {
double
vertexPropValue =
vPropIter.get() ; long
edgePropValue =
}ePropIter.get();

In order to access the vertex property of the neighbor vertex, the neighbor iterator provides the corresponding vertex index which is available in a neighbor list in a delta-logged list-array (forward CSR). Using the neighbor iterator, the following are two major optimizations compared to neighbor traversal using the delta-logged list-array directly.

Because neighbor lists are either stored in the base lists array or in the delta-lists array (but not fragmented and stored in both), it is sufficient to check at the beginning of the traversal where the neighbor list is stored. As a comparison, when using the delta-logged list array directly, each neighbor access entails one check of where the neighbor list is stored even though it is always at the same location. This check can be expensive because it involves a hash map access that incurs indirection and possibly also collision resolution such as linear scanning of a hash bucket.

Similarly, determining the begin index in the base lists array or respectively in the delta-begin array can be done once per traversal instead of once per neighbor vertex.

/* initializing the traversal context (once per
traversal rather than once per neighbor access) */
public void setCurrentVertex(int idx) {
this.sourceVertex = idx;
/* check if the neighbor list is in the delta-
lists array or in the base lists */
arraythis.isInLogs =
idxToDeltaListMap.containsKey(idx) ;
/* setting up
bounds for
traversal */
if (isInLogs)
{
int deltaListIndex =
idxToDeltaListMap.get(idx)
; this.listStart =
deltaListBegin.get(deltaLi
stIndex) ;
this.listEnd = deltaListBegin.get(deltaListIndex + 1);
} else {
this.listStart =
beginArray.get(id
x); this.listEnd
beginArray.get(id
x + 1);
}
}this.listOffset = 0;

Once the neighbor list has been located and the corresponding begin and end indices have been determined, iterating over the neighbor vertices entails incrementing a list offset by one each time.

/* move the iterator to
the next edge, return
success public */
boolean nextEdge() {
listOffset++;
// precomputed neighbor list bound
if (listOffset >= listEnd) return false;
/* precomputed field to check
if neighbor list is in logs */
if (isInLogs) {
this.destinationVertex = deltaLists.get(listStart +
listOffset) ;
} else {
this.destinationVertex = lists.get(listStart +
}}listOffset) ;
return true;

Somewhat similar to vertex range traversal, vertex property iterators query the vertex index from the forward neighbor iterator and need to check if the property value is stored in delta logs or not.

Accessing edge properties occurs as follows. Somewhat similar to neighbor vertices, edge properties are stored in delta-logged list-arrays. Therefore, edge property iterators have an traversal setup that is somewhat similar to the forward neighbor iterator in setCurrentVertex. The value lists for a given source vertex are not necessarily at the same location (delta-lists array or base lists array) as the corresponding neighbor list in the CSR. It is therefore necessary to perform a separate setup in each edge property iterator, including determining separate listStart and isInLogs fields. After the traversal context initialization, the edge property iterator queries the listOffset field of the forward neighbor iterator.

Somewhat similar to vertices, special direct edge property iterators for edge properties that are allocated by the graph algorithm can be implemented so as to remove the delta-log checks and instead use direct accesses into unmanaged (e.g. off-heap) memory as discussed earlier herein and as follows.

### Direct Vertex Property Iterator

Graph algorithms such as PageRank, weakly connected components, and others create either temporary properties to store data useful for the computations, or output properties that will be transmitted back to the client. Because those properties are created during the algorithm only for a specific version of the graph, it is guaranteed that those properties in that graph version do not have delta-logs, which can be leveraged to simplify a property iterator as follows.

Having specific iterators for those properties enables removing some of the checks of delta logs and instead directly accesses memory using the Java Unsafe application program interface (API) in an embodiment. The following is the get method of a direct property iterator.

public double get() {
int idx = rangeIter.getCurrentVertex();
return UNSAFE.getDouble(null, baseAddress + (idx *
}TYPE_DOUBLE_SIZE)));

### Example Reverse Neighbor Iterator

A reverse neighbor iterator is implemented somewhat similarly to the forward neighbor iterator. Instead of using the forward CSR, the reverse CSR is used. One difference is that the reverse neighbor iterator additionally assists with the lookup in the eRev2Idx mapping if the iterator is used in conjunction with edge property iterators. This is necessary because edge properties are ordered according to the forward CSR rather than the reverse CSR as explained earlier herein.

The reverse neighbor iterator exposes the eRevOffset value to the edge property iterator which can fulfil a mapping by adding the begin index of the property value list in either the base lists array or in the delta-lists array. The begin index needs to be computed inside the edge property iterator because the neighbor lists in the reverse CSR might not be in the same location (base lists array or delta-lists array) as the value list in the property delta-logged array.

/* accessing a boolean edge
property of a reverse edge */
public boolean get() {
long eRevOffset = rNeighborIterator.getERevOffset(); /*
computed for each edge */
int sourceVertex = rNeighborIterator.getSourceVertex(); //
the neighbor vertex, computed for each edge
/* accessing the property value either in the base lists
array or the delta-lists array
the location needs to be checked for every access since the
neighbor lists might be different each time */
if (deltaLists != null &&
idxToDeltaListMap.containsKey(sourceVertex)) {
long deltaListStart =
idxToDeltaListMap.get(sourceV
ertex) ; return
logArray.get(deltaListStart +
eRevOffset);
}
long listStart =
beginArray.get(sourceV
ertex) ; return
lists.get(listStart +
}eRevOffset);

In the above logic, the offset value and the begin index need to be computed for each edge. However, by using a reverse neighbor iterator, these lookups are performed only once for all edge properties. Furthermore, the logic avoids an additional lookup of the begin index of the reverse neighbor list (one of the components of the eRev2Idx mapping) by only doing the offset lookup and adding it to the begin array of the value list of the property directly.

When traversing reverse edges and directly accessing delta-logged data structures (i.e. no reverse neighbor iterator) the eRev2Idx mapping would be accessed for each edge and each edge property.

Somewhat similar to forward edge property iterators, special direct reverse edge property iterators for edge properties that are allocated by the graph algorithm can be implemented and remove the delta-log checks, and instead directly access unmanaged memory.

### Example Deletion Bitmaps

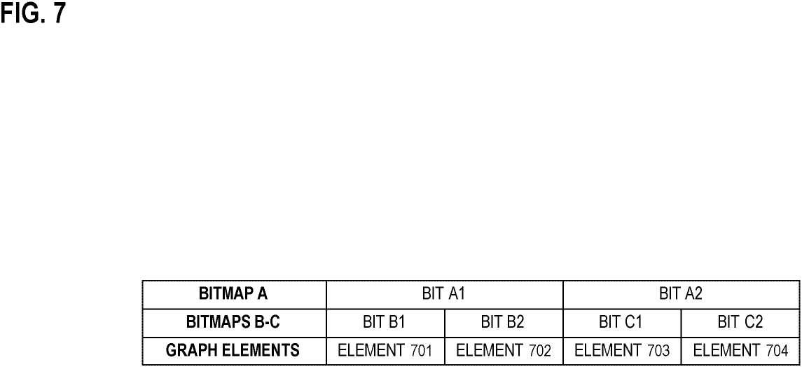

FIG. 7 is a block diagram that depicts example bitmaps A-C that track which of graph elements 701-704 were deleted from an example graph (not shown).

As explained earlier herein, a delta log is a data structure that tracks changes to a graph. The delta log may itself be a composite of substructures with various respective purposes. In this embodiment, the delta log contains example bitmaps A-C to track element deletions. Element iterators herein accelerate by checking bitmaps A-C to detect whether or not any of graph elements 701-704 can be skipped during iteration. A graph element is either skipped or accessed during iteration. Checking bitmap(s) is faster than traversing the delta lists of FIG. 6 to detect that a graph element was deleted.

As shown, bitmap B contains bits B1-B2, and bitmap C contains bits C1-C2. Each of bits B1-B2 and C1-C2 indicates whether or not respective graph elements 701-704 were deleted. For example, an element iterator may detect that bit B1 is set to indicate that graph element 701 was deleted. Based on that detection, the element iterator should not provide access to graph element 701 and instead skip graph element 701 during iteration.

Bitmaps may be hierarchically used such that bitmap A may provide a summary of bitmaps B-C in a way that may save time and space as follows. Bitmap A contains bits A1-A2 that indicate whether any of the bits in bitmaps B-C were set as indicating deletion. For example, either or both of bits B1-B2 were set as indicating deletion if bit A1 is set.

Detecting that no graph elements were deleted may entail inspecting two bitmaps B-C or, for acceleration, may instead entail inspecting only one bitmap A. For example if bits A1-A2 are clear, then necessarily so too are all of bits B1-B2 and C1-C2. Hierarchical bitmaps save memory by deferring dynamic allocation of a bitmap until a first one bit is set in the bitmap. For example, bits A1-A2 can additionally indicate which of bitmaps B-C are already allocated. For example, bitmap C may be allocated but not bitmap B. Dynamic allocations of bitmaps A-C may mean that bitmaps A-C are not stored adjacent to each other in memory.

The following enumerated pairs i-ii of respective steps a-b demonstrate important scenarios that use deletion bitmap(s).
i. a) associating a first element and a second element with respective bits in a first bitmap and then b) verifying that the respective bits are clear;
ii. in a same or different scenario than (i) above: a) associating both of the first element and the second element with a single bit in a second bitmap and then b) detecting that the single bit is set.

### Example Stack-Based Iterator

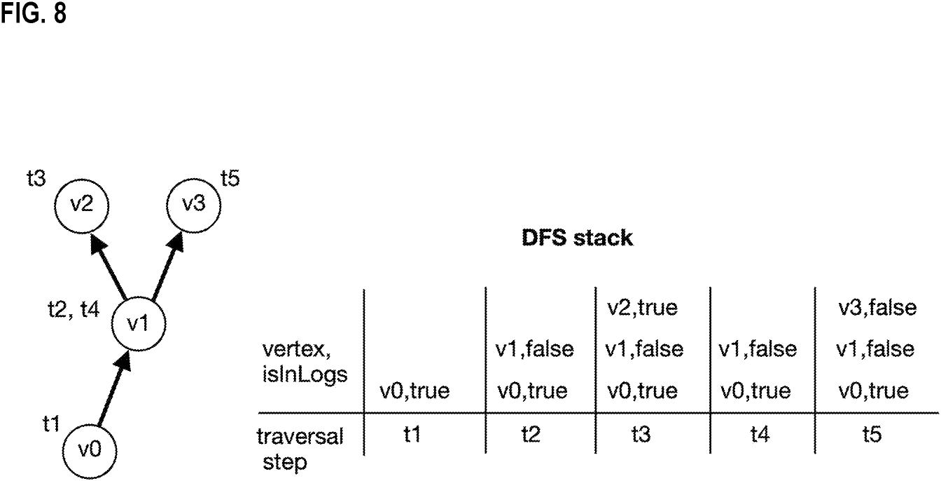

FIG. 8 is a block diagram that, on the left side, depicts an example graph and, on the right side, depicts an example stack of a stack-based iterator. The stack-based iterator (not shown) contains the shown stack, and together they are used to iterate vertices of the shown graph in a depth first search (DFS) ordering. The graph contains vertices v0-v3 that are iterated in a DFS ordering as the numbering of vertices v0-v3 suggests. For example, the stack-based iterator provides access to vertex v0 first and vertex v3 last.

As an initialization parameter, the stack-based iterator accepts an initial vertex that, in this example, is vertex v0. During initialization, the stack is empty, and the stack-based iterator pushes vertex v0 onto the stack. Whenever a vertex is pushed onto the stack, the stack-based iterator provides access to that vertex as a next vertex during iteration.

For demonstration, both of the graph and the stack show traversal steps t1-t5 that occur sequentially in the ordering that the numbering of traversal steps t1-t5 suggests. For example, traversal step t1 occurs first, and traversal step t5 occurs last. As shown, the stack grows upwards while time elapses rightwards. Each entry in the stack contains a pair of data items that contain an identifier of a vertex and a Boolean that indicates whether or not the identifier of the vertex is contained in a delta log. Backtracking during DFS entails revisiting vertices.

For acceleration, stack entries contain such data that may otherwise be expensive to obtain by inspecting a delta log. When a vertex is pushed onto the stack, whether or not the delta log contains the vertex is detected only once and stored with the vertex as a pair in a stack entry. During backtracking, delta log access is avoided by checking Boolean isInLogs in a stack entry. For example in traversal step t2 when DFS traversal first reaches vertex v1: a) vertex v1 is detected as absent from the delta log, which b) is recorded in a pair that is pushed onto the stack. When backtracking causes vertex v1 to be revisited in traversal step t4 as shown, acceleration occurs by not inspecting the delta log again for vertex v1 because Boolean isInLogs already indicates the previous result of such inspection.

Access to a vertex during iteration is provided only when the vertex is pushed onto the stack. Vertex v1 is retained in the stack during traversal steps t2-t5, although vertex v1 is iterated only during step t2. After pushing a vertex onto the stack and providing the vertex in the iteration, the stack-based iterator may use a neighbor iterator to iterate neighboring vertices of the pushed vertex, and all of those neighbor vertices are then pushed onto the stack and iterated. However per DFS and although not shown, pushing and iterating of a first neighbor and a second neighbor is temporally separated by pushing and iterating neighbors of the first neighbor. Stack-based iteration ceases when the stack becomes empty.

### Example Iteration Process

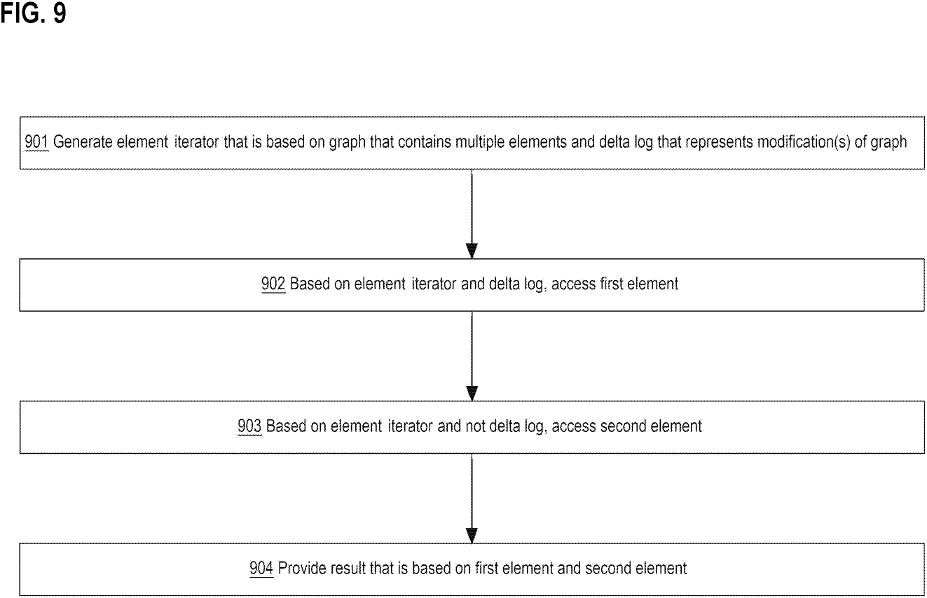

FIG. 9 is a flow diagram that depicts an example process that a computer may perform to iterate some or all graph elements (i.e. vertices, edges, or properties) of a graph.

Step 901 generates an element iterator that is based on: a) a graph that contains multiple elements and b) a delta log that represents (e.g. topological) modification(s) of the graph. For example, the element iterator may store references to: a) the forward and/or backward CSR of FIG. 2, including some or all substructures such as nodeIdx and eRevOffset, b) delta log structures such as in FIGS. 5-6, c) bitmaps of FIG. 7, and/or d) other element iterators such as when a property iterator delegates edge iteration to an edge iterator or a neighbor iterator. The element iterator may also contain an offset that indicates which graph element is the element iterator currently visiting.

Based on the element iterator and the delta log, step 902 provides access to a first element. For example as explained earlier for FIG. 6, the element iterator may be a neighbor iterator for vertices 0-2 and may use delta lists to iterate vertices 0 and 3-4 as neighbors of vertex 0 as shown in FIG. 6.

Based on the element iterator but not the delta log, step 903 provides access to another element. For example, the neighbor iterator may, without using the delta lists, iterate vertices 2 and 4 as neighbors of vertex 2 as shown in FIG. 6.

General use of element iterators need not generate a result. Step 904 provides a result that is based on the first element iterated by step 902 and second element iterated by step 903. For example, age and color may be vertex properties, and step 904 may generate a result that contains all blue vertices or an average age of all blue vertices. The result may subsequently be internally used such as an intermediate result that contributes to further processing of a graph query or instead is sent to a client as a final result.

### Enumerated Embodiments

The following enumerated embodiments demonstrate use cases and design choices that may be based on using, enhancing, and/or combining embodiments presented earlier herein. The enumerated embodiments variously are or are not mutually exclusive and can or cannot be combined as a single iterator. Any of the enumerated embodiments that iterate graph elements may variously iterate only vertices, only edges, only their properties, only a particular property of theirs, or unions of those graph elements. For example, an embodiment may iterate only edge color.
i. An element iterator iterates respective values of a particular property for graph elements in the graph.
ii. An element iterator iterates: a) neighbor vertices that are connected by respective edges to a particular vertex in the graph or b) those edges.
iii. An element iterator iterates all graph elements of a graph component such as an entire graph or a connected subgraph of the graph.
iv. An element iterator iterates graph elements identified by respective integers, such as array offsets, in an entire range or a specified subrange of integers.
v. An element iterator iterates graph elements: a) in a specified and repeatable ordering or b) in the reverse of that ordering.

### Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, (e.g. Oracle Database 11g). SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

### Query Optimization and Execution Plans

Query optimization generates one or more different candidate execution plans for a query, which are evaluated by the query optimizer to determine which execution plan should be used to compute the query.

Execution plans may be represented by a graph of interlinked nodes, each representing an plan operator or row sources. The hierarchy of the graphs (i.e., directed tree) represents the order in which the execution plan operators are performed and how data flows between each of the execution plan operators.

An operator, as the term is used herein, comprises one or more routines or functions that are configured for performing operations on input rows or tuples to generate an output set of rows or tuples. The operations may use interim data structures. Output set of rows or tuples may be used as input rows or tuples for a parent operator.

An operator may be executed by one or more computer processes or threads. Referring to an operator as performing an operation means that a process or thread executing functions or routines of an operator are performing the operation.

A row source performs operations on input rows and generates output rows, which may serve as input to another row source. The output rows may be new rows, and or a version of the input rows that have been transformed by the row source.

A match operator of a path pattern expression performs operations on a set of input matching vertices and generates a set of output matching vertices, which may serve as input to another match operator in the path pattern expression. The match operator performs logic over multiple vertex/edges to generate the set of output matching vertices for a specific hop of a target pattern corresponding to the path pattern expression.

An execution plan operator generates a set of rows (which may be referred to as a table) as output and execution plan operations include, for example, a table scan, an index scan, sort-merge join, nested-loop join, filter, and importantly, a full outer join.

A query optimizer may optimize a query by transforming the query. In general, transforming a query involves rewriting a query into another semantically equivalent query that should produce the same result and that can potentially be executed more efficiently, i.e. one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

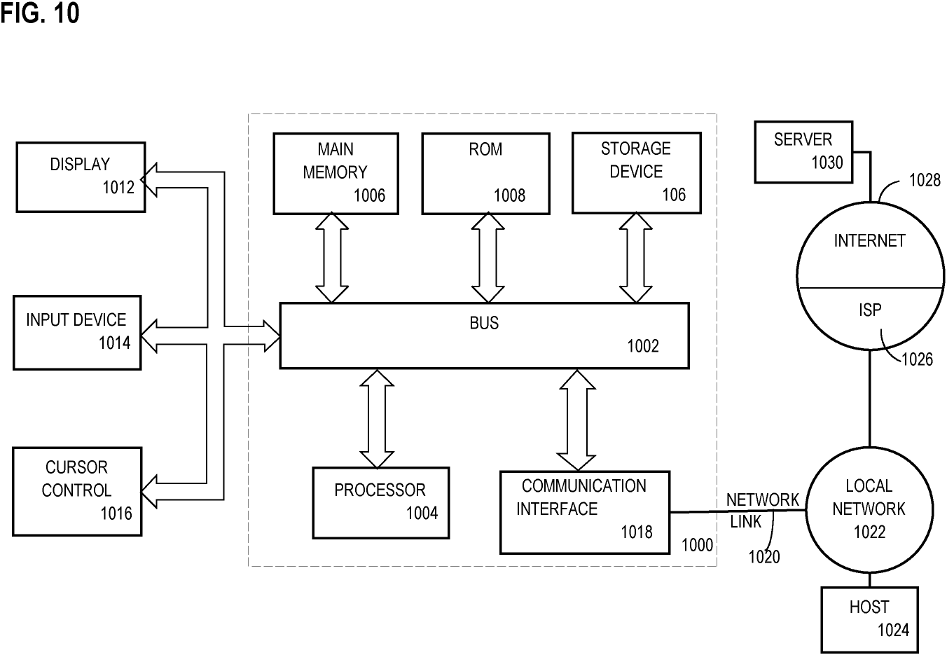

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

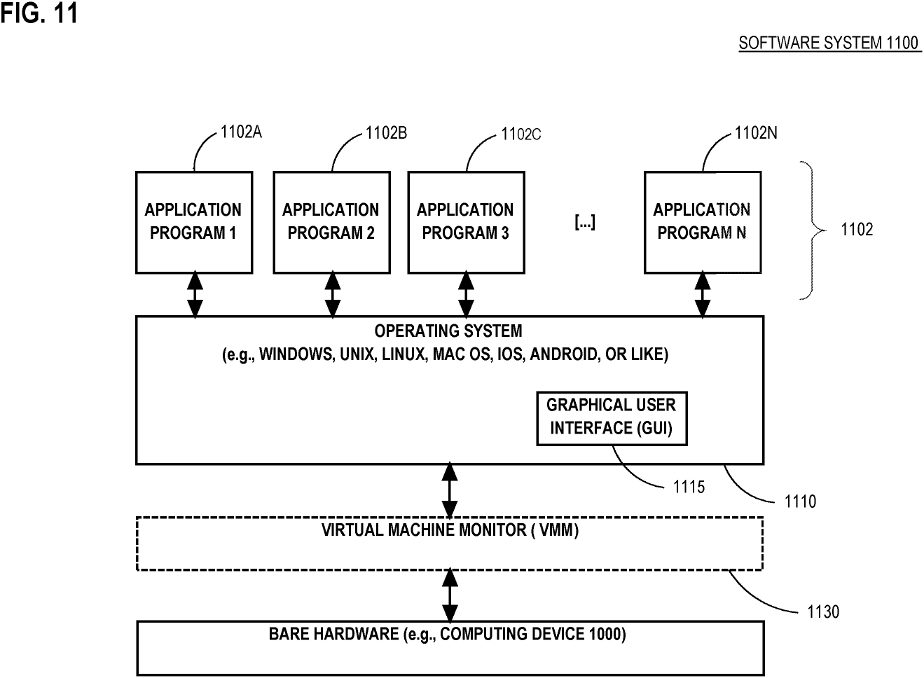

FIG. 11 is a block diagram of a basic software system 1100 that may be employed for controlling the operation of computing device 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computing device 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C ... 1102N, may be “loaded” (e.g., transferred from fixed storage 1010 into memory 1006) for execution by the system 1100. The applications or other software intended for use on device 1100 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of device 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the device 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of device 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Extensions and Alternatives

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method comprising:
generating an element iterator that is based on a graph that contains a plurality of elements and a delta log that represents one or more topological modifications of the graph;
accessing, based on the element iterator and the delta log, a first element of the plurality of elements;
accessing, based on the element iterator and not the delta log, a second element of the plurality of elements;
providing a result that is based on the first element and the second element.

2. The method of claim 1 wherein the element iterator iterates one selected from the group consisting of:
respective values of a particular property for vertices in the graph,
respective values of a particular property for edges in the graph,
neighbor vertices that are connected by respective edges to a particular vertex in the graph,
all vertices of a graph component selected from the group consisting of the graph and a subgraph of the graph, and
all edges of a graph component selected from the group consisting of the graph and a subgraph of the graph.

3. The method of claim 1 wherein:
at least one selected from the group consisting of each vertex in the graph is identified by an integer in a first range of integers and each edge in the graph is identified by an integer in a second range of integers;
the element iterator iterates based on a subrange of one selected from the group consisting of the first range and the second range.

4. The method of claim 1 wherein:
the element iterator iterates the plurality of elements in a particular ordering;
the method further comprises generating a reverse iterator that iterates the plurality of elements in the reverse of the particular ordering.

5. The method of claim 1 wherein said accessing the first element comprises removing the first element from a set of distinct elements.

6. The method of claim 5 wherein said set of distinct elements is selected from the group consisting of a queue and a stack.

7. The method of claim 1 wherein:
the method further comprises identifying a first vertex and a second vertex in the graph;
the element iterator iterates neighbor vertices that are connected by respective edges to both of the first vertex and the second vertex.

8. The method of claim 1 further comprising:
associating the first element and the second element with respective bits in a bitmap;
verifying that said respective bits are clear.

9. The method of claim 8 further comprising:
associating both of the first element and the second element with a single bit in a second bitmap;
detecting that said single bit is set.

10. The method of claim 1 further comprising:
associating both of the first element and the second element with a single bit in a bitmap;
verifying that said single bit is clear.

11. The method of claim 1 further comprising, for data selected from the group consisting of (a) the first element and the second element and (b) respective identifiers of the first element and the second element, the element iterator performing at least one selected from the group consisting of prefetching said data and concurrently processing said data.

12. The method of claim 10 wherein said concurrently processing said data comprises the element iterator using single instruction multiple data (SIMD).

13. The method of claim 10 wherein:
the first element and the second element are stored in a heap;
said data are not stored in a heap.

14. The method of claim 1 wherein the element iterator is further based on a base data structure that represents said graph before said one or more topological modifications of the graph.

15. The method of claim 14 wherein said accessing the first element is further based on at least one selected from the group consisting of the base data structure, a forward compressed spare row (CSR) structure, and a reverse CSR structure.

16. The method of claim 1 wherein:
said delta log represents only said one or more topological modifications;
each modification of said one or more topological modifications changes a count of elements in said graph.

17. One or more non-transitory computer-readable media storing instructions that, when executed by one or more processors, cause:
generating an element iterator that is based on a graph that contains a plurality of elements and a delta log that represents one or more topological modifications of the graph;
accessing, based on the element iterator and the delta log, a first element of the plurality of elements;
accessing, based on the element iterator and not the delta log, a second element of the plurality of elements;
providing a result that is based on the first element and the second element.

18. The one or more non-transitory computer-readable media of claim 17 wherein the element iterator iterates one selected from the group consisting of:
respective values of a particular property for vertices in the graph,
respective values of a particular property for edges in the graph,
neighbor vertices that are connected by respective edges to a particular vertex in the graph,
all vertices of a graph component selected from the group consisting of the graph and a subgraph of the graph, and
all edges of a graph component selected from the group consisting of the graph and a subgraph of the graph.

19. The one or more non-transitory computer-readable media of claim 17 wherein the instructions further cause, for data selected from the group consisting of (a) the first element and the second element and (b) respective identifiers of the first element and the second element, the element iterator performing at least one selected from the group consisting of prefetching said data and concurrently processing said data.

20. The one or more non-transitory computer-readable media of claim 17 wherein the instructions further cause:
associating the first element and the second element with respective bits in a bitmap; verifying that said respective bits are clear.
